(19) United States
(12) Patent Application Publication
(10) Pub. No.: US 2015/0083527 A1
(43) Pub. Date: Mar. 26, 2015

(54) Back-up brake system of lifts

(71) Applicant: Yexiong Liu, Guangzhou (CN)

(72) Inventor: Yexiong Liu, Guangzhou (CN)

(21) Appl. No.: 14/454,728

(22) Filed: Aug. 8, 2014

(30) Foreign Application Priority Data
Sep. 25, 2013 (CN) 201310442166.4

(51) Int. Cl. B66B 5/16; B66B 5/00; B66B 5/26

(52) U.S. Cl. CPC B66B 5/16; B66B 5/26; B66B 5/00
USPC 187/348

(57) ABSTRACT

The invention provides a back-up brake system of lifts, which is inclusive of a back-up safety cable, guiding wheels and a brake, wherein four guiding wheels are mounted at the four corners of the lift car, the upper end of the back-up safety cable is fixed at the shaft way top, runs through the four guiding wheels and then its lower end is connected with the extension spring at the shaft way bottom; the brake is mounted in the middle of the car bottom, which is further inclusive of hydraulic wrenches and gear rope grippers. Operation of the system is such that the hydraulic wrenches run through the rope grippers and drive them to turn, while the back-up safety cable through the opening on the rope grippers, which the gear rope gripper in the upper and lower rows, turn in different directions to seize the back-up safety cable.

### BACKGROUND OF THE INVENTION

1. Field of the Invention

The invention relates to a type of lift component and more particularly to a kind of lift brake system.

2. Description of Related Art

The past two decades have witnessed rapid development of real estate in China which evolves elevators and lifts into a necessity of life. However, an overwhelming majority of lifts become outdated as time goes by. It is not farfetched at all to label lift as a highly dangerous device, since people riding a lift might be completely deprived of self-rescue ability in the event of an accident. Lifts which have been used for a couple of years are particularly prone to frequent accidents due to degraded performance and functionality, resulting in heavy personal injury and property loss.

Lift brake system of the prior art comprises two parts, namely, the brake entrains the motor's back at the top of the lift shaft and the electrical system controls the cable brake to stop the car. A block brake is located on both sides of the car and grips the lift rail so that the car is braked. Both the block brake and the rail are subject to abrasion and the latter requires for a complex process and a high cost to replace. The disadvantage lies in that whenever the car takes on free drop due to an electrical control failure or a broken main cable, the electrical control will be made unable to operate the brake while the block brake of the car is not powerful enough to stop the car which can but drop freely without any compensation, which is a frequent occurrence.

Old-fashioned lifts of the prior art are configured such that the rope grippers are installed in the machine room to clamp and brake the steel cable which is connected to the counterweight and the car. The process will be rather violent once started, resulting in heavy jittering of the car and the counterweight. The cable, car and counterweight will suffer material loss and the service life of the lift will be seriously jeopardized.

### SUMMARY OF THE INVENTION

To address the problems as mentioned above in background of the invention, the invention provides a back-up compensating brake system of lift which has a set of independent cable rope brake apparatus. The purpose lies in that whenever the lift car takes on free drop due to an electrical control device fails to control brake or a broken main cable, the hydraulic brake at the bottom of the lift car frame brakes the independent cable to stop the lift car. The invention features a structure based on the combination of cables and glide wheels so that the braking force is changed from vertical to horizontal to buffer and abate the lift car inertia, thereby providing a force to horizontally grip the cable to stop the lift.

For the aforesaid purpose, the invention adopts a technical solution as follows:

a back-up brake system of lift is positioned on the lift car, which is inclusive of a back-up safety cable, guiding wheels and a brake and is characterized in that: four guiding wheels are mounted at the four corners of the lift car; the upper end of the back-up safety cable is fixed at the lift shaft way top perpendicular to the guiding wheel at the upper right corner of the lift car, runs successively through the guiding wheels at the upper right corner, the upper left corner, the lower left corner and the lower right corner and then its lower end is connected with the extension spring at the shaft way bottom which is perpendicular to the guiding wheel at the lower right corner; the brake is mounted in the middle of the car bottom, which is inclusive of hydraulic wrenches and gear rope grippers. The hydraulic wrenches run through the rope grippers and drive them to turn, while the back-up safety cable runs through the opening on the rope grippers, which the gear rope gripper in the upper and lower rows, turn in different directions to seize the back-up safety cable.

The back-up safety cable is fixed at the shaft way top with a hook.

A fixed beam which four guiding wheels are welded is welded on the upper side, left side and lower side of the lift car.

Wherein gear rope grippers are six in number, three each in the upper and lower rows.

Gear rope grippers in the upper and lower rows are arranged apart.

The switches of the hydraulic wrenches are linked with the control cabinet of the lift car and are switched off when the car overspeeds.

The switches of the hydraulic wrenches series connected with the car door opening/closing signal, the hydraulic wrenches are switched off when the car door opens and on when the car door closes.

An emergency stop button with a glass cover is independently positioned in the lift car and linked with the switches of the hydraulic wrenches.

The invention will render beneficial effects as follows:

The invention does not necessarily change the original brake system of lift in that it is an additional set of independent compensating brake system comprising a steel cable, four glide wheels and two sets of hydraulic wrenches, where the cable is fixed and the car moves up and down on it relying on the four glide wheels while the two sets of hydraulic wrenches rotate to grip the cable, with each wrench applying a bite force up to 10,000 n.m to stop the car. The invention is able to co-exist with the original system and can open like a back-up parachute in the event of any electronic or physical failure in the original brake system to ensure personal safety.

In the event of a failure in the lift, when the car moves up and down abnormally regardless of whether it is due to a broken cable, a brake failure or a failure in the control cabinet and the passenger cannot change or stop such movement, The invention is advantageous in that at this moment, the back-up compensating brake system can be either automatically or manually activated so that the car is able to stop up-down movement for rescue. Furthermore, the invention enables replacement of the safety cable and the brake in a cost-efficient after a period of operation and simple procedure. Installation of the invention on a lift which has been run for years can effectively deter the occurrence of casualty accident at a low cost of operation and maintenance and significantly improve the lift running safety.

The above and other objects, features and advantages of the invention will become apparent from the following detailed description taken with the accompanying drawings.

### BRIEF DESCRIPTION OF THE DRAWINGS

FIG. 1 is a front schematic view of embodiment 1 of the invention. FIG. 2 is a three-dimensional schematic view of embodiment 1 of the invention.

FIG. 3 is a detail plan of node A in FIG. 2.

FIG. 4 is an operation schematic view of the gear rope gripper when the car door opens in embodiment 1 of the invention.

FIG. 5 is a schematic view when the gear rope gripper seizes the back-up safety cable in embodiment 1 of the invention.

Where: 1. machine room; 2. cable; 3. guide rail of the car; 4. back-up safety cable; 5. guiding wheel; 6. car frame; 7. guide shoes of the car; 8. gear rope gripper; 10. extension spring; 11. shaft bottom; 12. hydraulic wrench.

### DETAILED DESCRIPTION OF THE INVENTION

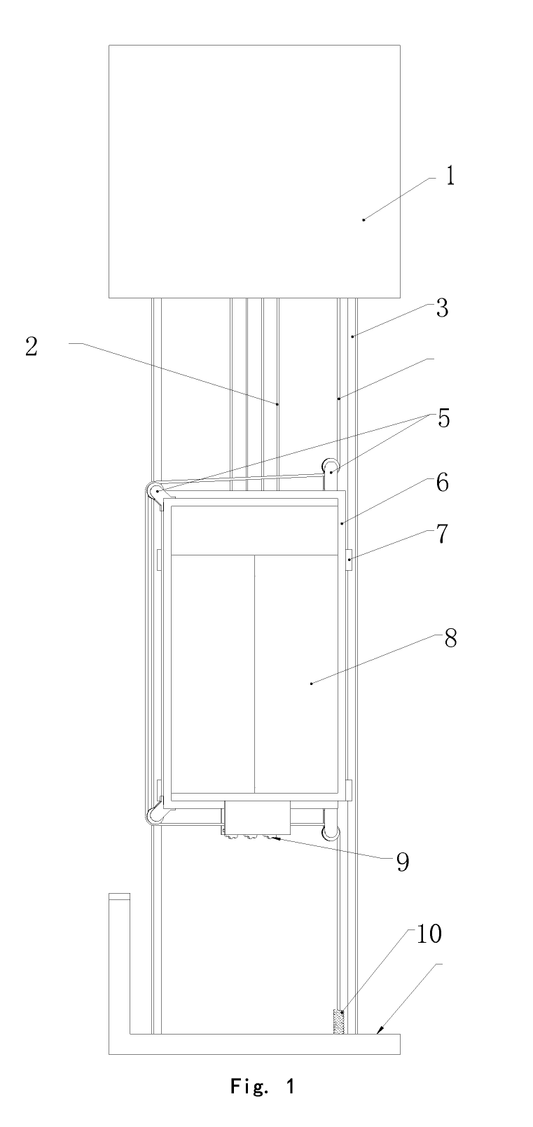

Referring to FIGS. 1 to 5, the invention is shown.

### Embodiment 1

As shown in FIG. 1, the cable 2 linked with the traction motor in the machine room 1 from where it stretches out and linked with the car 8, the traction motor drives the traction sheave to turn through the reducer changes speed, where a tractive force is generated from friction between the traction rope and the traction sheave to enable up-down movement of the lift car and the counterweight, thereby realizing the transport purpose. Guide shoes 7 fixed on the lift car 8 can rise and fall in a reciprocate manner along the guide rails 3 of the lift car is arranged on the walls of the building shaft to prevent the lift car from deflection or swing during operation.

A vertical beam is parallel welded aside the vertical beam on the left side of the original lift car frame, where its bottom is 25 cm further stretched down than that of the original frame top and its top is about 25 cm lower than that of the original frame bottom. A horizontal beam is girded at the upper end of the vertical beam and welded firmly, with its length stretched underneath the right upper endpoint of the original frame. A horizontal base beam is girded at the lower end of the vertical beam and welded firmly, with its length stretched underneath the upper right endpoint of the original frame. At this point, the welded 3 beams form a capitalized English letter of C to make a certain included angle with the original frame, in order to ensure points of weld are as many and firmly welded as possible.

One guiding wheel 5 is positioned at the endpoint of the upper right corner of the original frame and another one is positioned at the left endpoint of the welded horizontal beam. Again, one guiding wheel is positioned at the left endpoint of the welded horizontal bottom beam and another one is positioned at the right endpoint of the welded horizontal bottom beam, hence the four guiding wheels distributed at the four endpoints. A back-up safety cable 4 is fixed on a hook at the shaft way top (right above the guiding wheel at the upper right corner of the lift car), runs successively through the four guiding wheels 5 and eventually hooks on an extension spring 10 (right below the guiding wheel at the lower right corner of the lift car) fixed at the shaft way bottom. When the lift car 8 moves up and down, it also moves up and down on the back-up safety cable 4 through the guiding wheels.

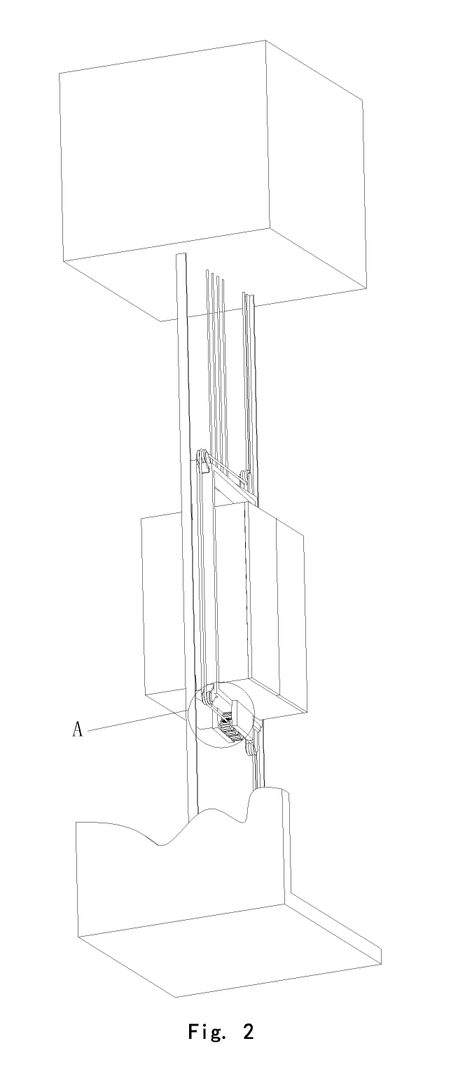

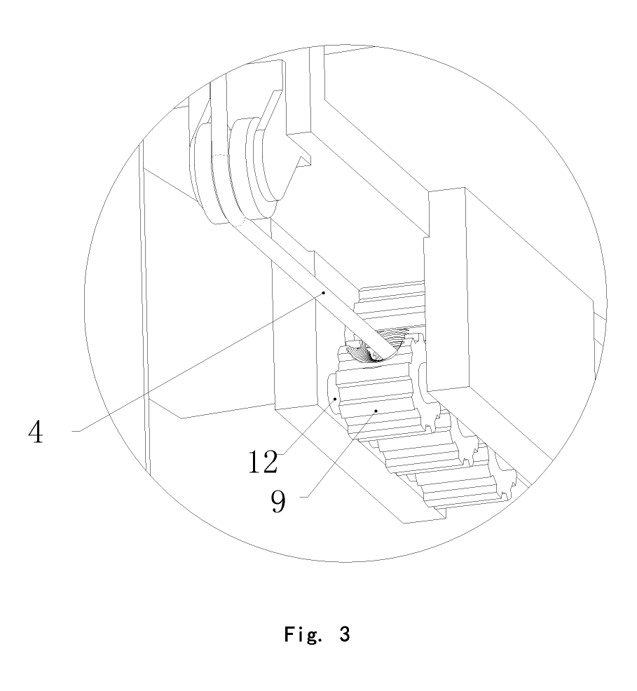

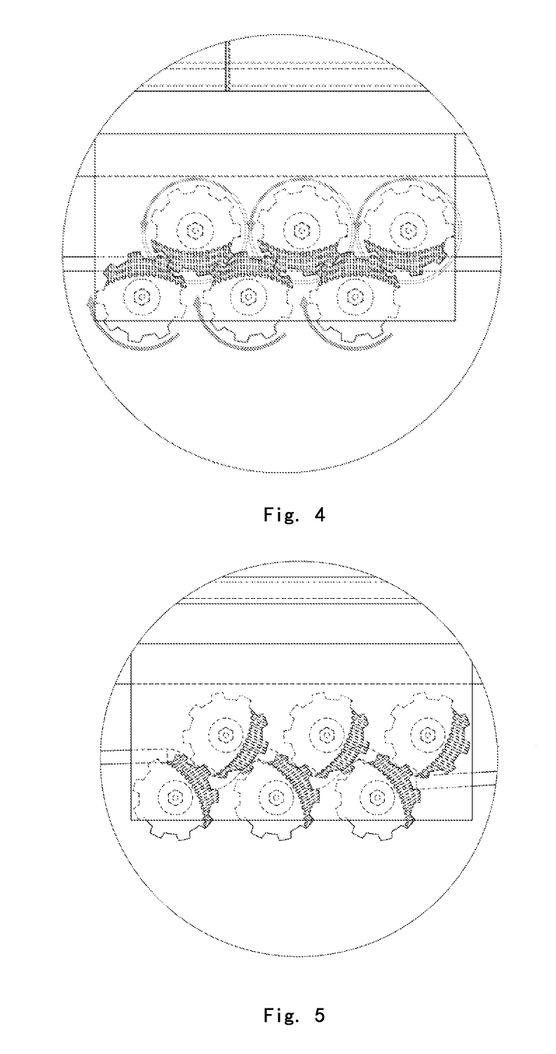

A set of six gear rope grippers 9 which is void in middle part are fixed on the welded horizontal beam, which are run through by the hydraulic wrenches 12 and driven to rotate, three each in the upper and lower rows, rotating at an angle of 27 degrees per time and totaling up to three times in a continuous turn about 80 degrees. An opening is positioned on the six respective gear rope grippers (as shown in FIG. 3) in the upper and lower rows, which is run through by the opening the back-up safety cable. When the lift door opens, the hydraulic wrenches become energized and the upper three rope grippers turn counterclockwise while the lower three turn clockwise to seize the back-up safety cable (as shown in FIGS. 4 and 5). When the lift door closes, they turn in reverse direction and return to normal.

Each hydraulic wrench weighs about 15 kg and the six hydraulic wrenches weigh about 150 kg plus the three welded I-beams, approximately equal to the weight of two adults, hence no impact on the normal operation of the lift. Each hydraulic wrench probably can provide a maximum torque up to 10,000 nm and an engaging force enough to fix the lift car onto the independent cable.

Operation of the brake system follows an operating procedure: 1. Signal of the switches of the hydraulic wrenches is series connected with the block brake signal of the control cabinet of the lift car, when the car overspeeds, the block brake is enabled and the hydraulic wrenches are switched off. 2. Signal of the hydraulic wrenches is series connected with the car door opening/closing signal, the hydraulic wrenches are switched off when the car door opens and on when the car door closes. 3. The emergency stop button with a glass cover only activates one-way closing signal to seize the cable.

While the invention has been described in terms of preferred embodiments, those skilled in the art will recognize that the invention can be practiced with modifications within the spirit and scope of the appended claims.

What is claimed is:

1. A back-up brake system of lift is positioned on the lift car, which is inclusive of a back-up safety cable, guiding wheels and a brake and is characterized in that: four guiding wheels are mounted at the four corners of the lift car; the upper end of the back-up safety cable is fixed at the lift shaft way top perpendicular to the guiding wheel at the upper right corner of the lift car, runs successively through the guiding wheels at the upper right corner, the upper left corner, the lower left corner and the lower right corner and then its lower end is connected with the extension spring at the shaft way bottom which is perpendicular to the guiding wheel at the lower right corner; the brake is mounted in the middle of the car bottom, which is inclusive of hydraulic wrenches and gear rope grippers; the hydraulic wrenches run through the rope grippers and drive them to turn, while the back-up safety cable runs through the opening on the rope grippers, which the gear rope gripper in the upper and lower rows, turn in different directions to seize the back-up safety cable.

2. The back-up brake system of lift as claimed in claim 1 is characterized in that the back-up safety cable is fixed at the shaft way top with a hook.

3. The back-up brake system of lift as claimed in claim 1 is characterized in that a fixed beam which four guiding wheels are welded is welded on the upper side, left side and lower side of the lift car.

4. The back-up brake system of lift as claimed in claim 1 is characterized in that the wherein gear rope grippers are six in number, three each in the upper and lower rows.

5. The back-up brake system of lift as claimed in claim 4 is characterized in that gear rope grippers in the upper and lower rows are arranged apart.

6. The back-up brake system of lift as claimed in claim 1 is characterized in that the switches of the hydraulic wrenches are linked with the control cabinet of the lift car and are switched off when the car overspeeds.

7. The back-up brake system of lift as claimed in claim 1 is characterized in that the switches of the hydraulic wrenches series connected with the car door opening/closing signal, the hydraulic wrenches are switched off when the car door opens and on when the car door closes.

8. The back-up brake system of lift as claimed in claim 1 is characterized in that an emergency stop button with a glass cover is independently positioned in the lift car and linked with the switches of the hydraulic wrenches.
